(19) United States
(12) Patent Application Publication
(10) Pub. No.: US 2015/0085624 A1
(43) Pub. Date: Mar. 26, 2015

(54) Computerized Medication Dosing

(71) Applicants: David Boyd Zamjahn, Chaska, MN (US); John C. Weinberger, Victoria, MN (US); James David Zamjahn, Richfield, MN (US); John Dahl, Plymouth, MN (US)

(72) Inventors: David Boyd Zamjahn, Chaska, MN (US); John C. Weinberger, Victoria, MN (US); James David Zamjahn, Richfield, MN (US); John Dahl, Plymouth, MN (US)

(21) Appl. No.: 14/497,305

(22) Filed: Sep. 25, 2014

Related U.S. Application Data
(60) Provisional application No. 61/882,134, filed on Sep. 25, 2013.

(51) Int. Cl. G04F 3/06; G06F 19/00

(52) U.S. Cl. CPC G04F 3/06; G06F 19/322; G06F 19/3456
USPC 368/109

(57) ABSTRACT

A method of dosing medication includes loading via a computerized system one or more user characteristics for a first user from a user profile for the first user, where the user characteristics include a weight of the first user. A dosing schedule is derived for a first medication from at least one of a type of the first medication and the one or more user characteristics for the first user, and a dosing amount is derived for the first medication from the one or more characteristics for the first user and the derived dosing schedule for the first user. A plurality of timer alerts are set corresponding to the derived dosing schedule, each of the timer alerts indicating the medication and derived dosing amount.

### CROSS-REFERENCE TO RELATED APPLICATIONS

This application claims priority to U.S. provisional patent application Ser. No. 61/882,134 (Attorney docket 104.001PRV), filed on Sep. 25, 2013, which is hereby incorporated by reference.

### FIELD

The invention relates generally to computerized medication dosing, and more specifically to using a computerized system to manage dosing of one or more medications.

### BACKGROUND

Managing medications properly can be a daunting task, particularly when managing multiple medications, medications for children or elderly, or when trying to manage and track a dosing schedule. Even many over-the-counter medications have confusing or potentially dangerous labeling, and can have incomplete or insufficient dosing information.

For example, a household having two sick children, including a three-year-old with a fever, can present a number of challenges. A bottle of children's acetaminophen may work for managing fevers in both children, but dosing instructions that indicate ½ teaspoon for a three-year-old also indicate that a child that age should weight 35-42 pounds rather than the 29 pounds the child actually weighs. Medication is being provided to both children, but in the middle of the night it is difficult to remember when the last dose was given to each child. Circumstances such as these can result in overdosing with medication, providing too little medication to be effective, or other such dosing errors.

According to published reports, 39% of caregivers are able to accurately select and dose children's acetaminophen in cases such as this. Many caregivers do not read and follow provided instructions in detail, and as much as 38% of caregivers give more than the recommended dose. The end result of such overdosing errors is two million American children hospitalized with over-the-counter dosing errors, and 200,000 dying as a result of such errors. Similarly, 55% of caregivers give less than the recommended dose, contributing to the 15 million children taken to emergency rooms every year with fever-related illnesses. This results in $1.4 billion spent on emergency room visits that may be preventable with more effectively managed dosing.

Similar problems exist for adults, such as adults who take excessive doses believing more is necessarily better, adults who wait too long or not long enough between doses, and adults who fail to complete a prescribed schedule for a medication. For example, an adult who is prescribed an antibiotic to be take over the course of 10 days may neglect taking the medication after three or four days, once the adult begins to feel better. This contributes to proliferation of antibiotic-resistant strains of many illnesses, and can harm both the patient and the community at large. An adult who takes multiple medications containing the same drug, such as acetaminophen, can similarly easily exceed the recommended 4000 grams per 24 hours, potentially causing significant liver damage.

Because inaccurate dosing of medications can result in an ineffective dose being given if the dose is too low or too infrequent, and can result in damage to the person being treated if the dose is too high or too frequent, accurate management of dosing amount and scheduling is an important part of managing the health of a person being treated with medication. It is therefore desirable to accurately manage dosing of medications, to ensure that the medications are effective but do not potentially harm the person being treated.

### SUMMARY

One example embodiment of the invention comprises a computerized method of dosing medication, including loading via a computerized system one or more user characteristics for a first user from a user profile for the first user, where the user characteristics include a weight of the first user. A dosing schedule is derived for a first medication from at least one of a type of the first medication and the one or more user characteristics for the first user, and a dosing amount is derived for the first medication from the one or more characteristics for the first user and the derived dosing schedule for the first user. A plurality of timer alerts are set corresponding to the derived dosing schedule, each of the timer alerts indicating the medication and derived dosing amount.

In a further example, access is provided to another user for at least one of the first user's user profile, user characteristics, dosing amount, dosing schedule, and timer alerts. Access is provided in various examples by a caregiver, parent, or guardian granting access to the first user's information, or by inclusion of another user in a group or circle of authorized caregivers for the first user.

In other examples, deriving a dosing schedule further comprises setting a schedule for alternating medications, setting a schedule based on at least one of meal schedule, sleeping hours, school hours, and other medications taken, or determining whether two or more medications contain ingredients that are the same or that interact and adjusting the dosing schedule based on the cumulative dose or interaction.

The details of one or more examples of the invention are set forth in the accompanying drawings and the description below. Other features and advantages will be apparent from the description and drawings, and from the claims.

### BRIEF DESCRIPTION OF THE FIGURES

FIG. 1 shows a computerized dosing system, consistent with an example embodiment of the invention.

FIG. 2 shows a smartphone with a computerized dosing system app, consistent with an example embodiment of the invention.

FIG. 3 shows a smartphone computerized dosing system app user profile information page, consistent with an example embodiment of the invention.

FIG. 4 is a flowchart of a method of initial profile generation, consistent with an example embodiment of the invention.

FIG. 5 is a flowchart of a method of providing computerized dosing, consistent with an example embodiment of the invention

FIG. 6 is a computerized system comprising a computerized dosing module, consistent with an example embodiment of the invention.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

Accurate dosing of medications is important to ensure that the medication dosing amount and time between doses of medication provides a safe yet effective level of medication. Medication amounts that are too big can have adverse effects, such as damaging body organs or causing death. Even over-the-counter medications such as acetaminophen can be dangerous, with a dose of double the 4000 g/day recommended limit for an adult being likely to cause liver damage. Medication amounts that are too low are also problematic in that they can be ineffective in treating a person's illness, resulting in extended or worsening illness, hospitalization, and other preventable problems

Similarly, failure to follow a prescribed dosing schedule can result in too much or too little medicine in a person's body. Medications are typically removed from the body at a known rate, and following prescribed dosing schedules ensures that the person does not wait too long between doses such that the medication level becomes ineffective, or wait too little between doses such that an overdose of medication accumulates in the person.

Further, failure to continue dosing for a prescribed length of a prescription can cause incomplete treatment of the person's medical condition, resulting in recurring illness, incomplete relief of symptoms, or other problems. Antibiotic-resistant strains of many bacterial infections are the result of failure to continue use of antibiotics for the entire course of prescribed treatment, such as discontinuing use of antibiotics as soon as a person starts to feel better.

Other medication challenges include managing doses for multiple children at the same time, particularly when the children need different doses or schedules for effective treatment. People taking multiple medications face additional challenges, such as ensuring that the cumulative amount of the same drug is taken into account where different medications contain the same drug, and managing staggered timing of complimentary medicines, such as using staggered dosing of acetaminophen and aspirin as antipyretics in managing fever.

Some embodiments of the invention therefore provide a computerized method of dosing medication, such as by using user characteristics including weight to derive a dosing schedule and amount. The derived dosing schedule and amount are used to set timer alerts corresponding to the derived dosing schedule, including the indicated medication, person, and derived dosing amount

In a further example, the computer system provides access to user profiles, alerts, dosing schedules, dosing amounts, or other such information for multiple users. Access is provided in various examples by a caregiver, parent, or guardian granting access to the first user's information, or by inclusion of another user in a group or circle of authorized caregivers for the first user.

In other examples, deriving a dosing schedule includes setting a schedule for alternating medications, setting a schedule based on at least one of meal schedule, sleeping hours, school hours, and other medications taken, or determining whether two or more medications contain ingredients that are the same or that interact and adjusting the dosing schedule based on the cumulative dose or interaction.

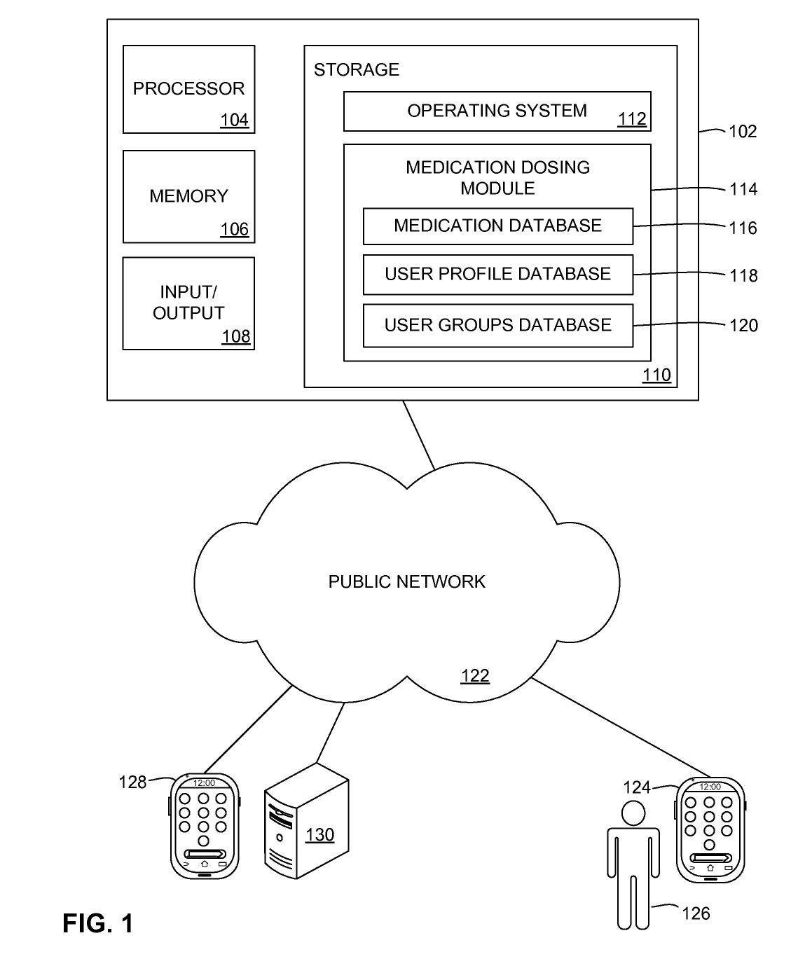

FIG. 1 shows a computerized medication dosing system, consistent with an example embodiment. Here, medication dosing server 102 comprises a processor 104, memory 106, input/output elements 108, and storage 110. Storage 110 includes an operating system 112, and a medication dosing module 114 that is operable to provide medication dosing to a user. The medication dosing module 114 further comprises a medication database 116 operable to store medication data, including information such as recommended dosing for people having various characteristics such as age, weight, symptoms or conditions, and other characteristics. The medication database in a further example includes information relating to time between doses for various dose amounts or various user characteristics. A user profile database 118 is operable to store user characteristics such as age, weight, allergies, chronic conditions or illnesses, and other such user characteristics. User group database 120 is operable to store user group information or other information regarding associations between various users, enabling users to share at least some information between users or within groups.

The medication dosing server 102 is connected to a public network 122, such as the Internet. Public network 122 serves to connect the medication dosing server 102 to remote computer systems, including user mobile device 124 (associated with user 126). Media recommendation system 102 is in this example further connected to other user computerized systems, including mobile device 128 and computer system 130.

In operation, the medication dosing server's processor 104 executes program instructions loaded from storage 110 into memory 106, such as operating system 112 and medication dosing module 114. The medication dosing module includes software executable to derive a medication dosing amount and dosing schedule from data stored in medication database 116 and user profile database 118, and to set one or more timer alerts for the medication corresponding to the derived dosing schedule.

In a more detailed example, a user such as user 126 uses a an app on smartphone 124 to create a user profile, such as including name, weight, and age. The user profile in some examples is stored locally on smartphone 124, and in other examples is stored in medication dosing server 102s user profile database 118. A medication is identified or prescribed, and dosing for the medication for the user is determined based on the user's weight. The dosing is determined in some examples on the smartphone, and in other examples is determined on the medication dosing server using medication information from medication database 116 and user weight information from user profile database 118. In a further example, other user characteristics such as age are used to derive medication dosing.

Dosing in a more detailed example includes a dosing schedule derived based on factors such as the type of medication, characteristics of the first user such as weight, and/or other factors, and a dosing amount derived based on the dosing schedule and on one or more user characteristics such as weight, age, and other such characteristics. Timer alerts are set on the smartphone 124 to alert the user of dosing schedule events, each of which indicates at least the medication and dose. In a further example, the alerts indicate other information, such as the user name and the dose time.

User characteristics stored in user profile database 118 in further examples include various combinations of information, including user name, weight, age, sex, current illness or condition, chronic medical conditions, allergies, sensitivities, meal schedule, sleeping hours, school hours, and other medications taken. In other examples, other information relevant to determining a medication dose and dosing schedule will be included in the user characteristics stored in the user profile database.

These user characteristics are used to determine dosing and dosing schedule, such as by basing amount of medicine to be administered at one time on a person's age, weight, condition, and other such factors. Weight is often the most meaningful consideration in determining medication dosing for a child, such that weight may have a greater influence upon the recommended dose than age or other factors. Although weight for adults is not as often considered in determining dosing amounts, many large people weigh three or more times many more petite adults, and using weight to determine appropriate dosing may benefit both.

For example, a child who is three years old may fall into a 3-5 year recommended dose for acetaminophen based on a weight of 35-50 pounds, but a three year old who weighs only 29 pounds may be administered a dose higher than necessary under such guidelines, putting the child at increased risk of suffering ill effects from a medication overdose. Such dosing miscalculations are often compounded by errors in dose measurement or time between doses, such that these errors compound or multiply to produce an increased risk to the person being treated.

For some medications, age or other factors will contribute or even be the primary factor in determining dosing. For example, immunizations may be based on age, along with well checks and other such medications or medical treatments. Similarly, a type of medication, such as a liquid rather than a tablet or gelcap may be prescribed based on the user's age rather than the user's weight, as younger people may manage liquids more easily than other forms of medication.

Dosing schedule is similarly derived from user characteristics such as weight, age, meal schedule, sleep schedule, school hours, and other such information. For example, a child having a medication that must be taken with food every eight hours might have a dosing schedule that provides for eight hours of uninterrupted sleep, but requires a dose with a meal upon waking up and upon going to bed for the night. Dosing in other examples might try to minimize the number of times a person wakes during the night to take medication, or minimize the number of doses that must be provided while at school or by a party other than the primary caregiver.

Dosing schedule in a further example is determined with consideration for one or more other medications taken, such as to avoid a cumulative effect from medications containing the same active ingredient, or staggering different medications to achieve a greater effect than a single medication may achieve. For example, a child taking a liquid cold medicine with acetaminophen as a component should not take other medications such as Tylenol that contain acetaminophen, or may have the dose of such other medications restricted to ensure that a maximum allowable dose is not exceeded. Similarly, drug interactions that may make a combination of medications unsafe are identified and an alert is created so that other medications can be selected.

Medications containing different active ingredients that are safe together may be staggered, such as where a child takes acetaminophen every four hours as an antipyretic to reduce fever, and also takes aspirin every four hours as a fever reducer. To obtain maximum effect, the medications are administered every two hours, staggered, such that the child alternates between doses of acetaminophen and aspirin. The resulting effect is a relatively high blood concentration of at least one of the two antipyretic medications in the child's blood at all times, and more effective fever reduction than would be obtained with either medication alone.

In a more complex example, an alternating dosing of acetaminophen and ibuprofen may be used to reduce fever in a sick child. But, because acetaminophen is commonly administered at a dose of 10 mg/kg to 15 mg/kg every 4 h and ibuprofen at a dose of 10 mg/kg every 6 h, a simple alternating regimen is not readily apparent. The method simplifies this dosing by either tracking this dosing schedule, or by modifying the dosing schedule such as to include 6-7 mg/kg of ibuprofen every four hours, alternating with acetaminophen. In a more sophisticated example, the dosing schedule for one or more medicines is derived to ensure that a blood serum level of the medication does not go below a minimum level, or remains between minimum and maximum levels. Dosing schedule in some examples also includes setting dosing alerts based on a specified number of days a medication should be taken, based on factors such as the medication, the condition being treated, and a doctor's prescription. For example, an antibiotic prescription may be provided for 14 or 20 days, but may have a 10 day minimum dosing schedule to ensure that a bacterial infection is completely cured. Similarly, some medications may be prescribed for 30 days at a time, but should be taken over a longer period of time. In a further example, the dosing application tracks medication on hand and dosing, and alerts the user when more medication will soon be needed.

Dosing amounts, dosing schedules, timer alerts, and other user information are in some examples used by a single user to manage that person's own health care, but in other examples are shared, such as where multiple parents or caregivers participate in caring for a child or elderly person. For example, a parent may give a child an 8 a.m. dose of medication before dropping the child off at a daycare, and forget to tell the daycare provider that the child has already received that dose of medication. The daycare provider is in a group or circle of users that are permitted access to the child's medication dosing schedule, and are able to use a mobile device 124, computer 130, or other mechanism to find that the medication dose has already been given, avoiding a potential overdose.

In further examples, the owner of a user profile such as is stored in database 118 is able to add authorization for various users to view one or more components of one or more user profiles, such as authorizing a daycare center to view dosing schedules and allergies, but not medical history or other selected profile information. Other users, such as parents or medical professionals, are similarly assigned different authorization based on their need to know various user information. Such information in some examples is stored in user groups database 118, or in a similar data structure.

Some embodiments do not operate in a client/server configuration, but include various features of medication dosing server 102 in a user device such as mobile device 124 or computer system 130. In one such example, a smartphone mobile device such as 124 includes the various features of medication dosing server 102, including a medication dosing module 116 along with one or more user profiles 118. User groups are in some such examples not included, but access to user information is provided to any user or is protected via means such as a password, pin number, or other such mechanism.

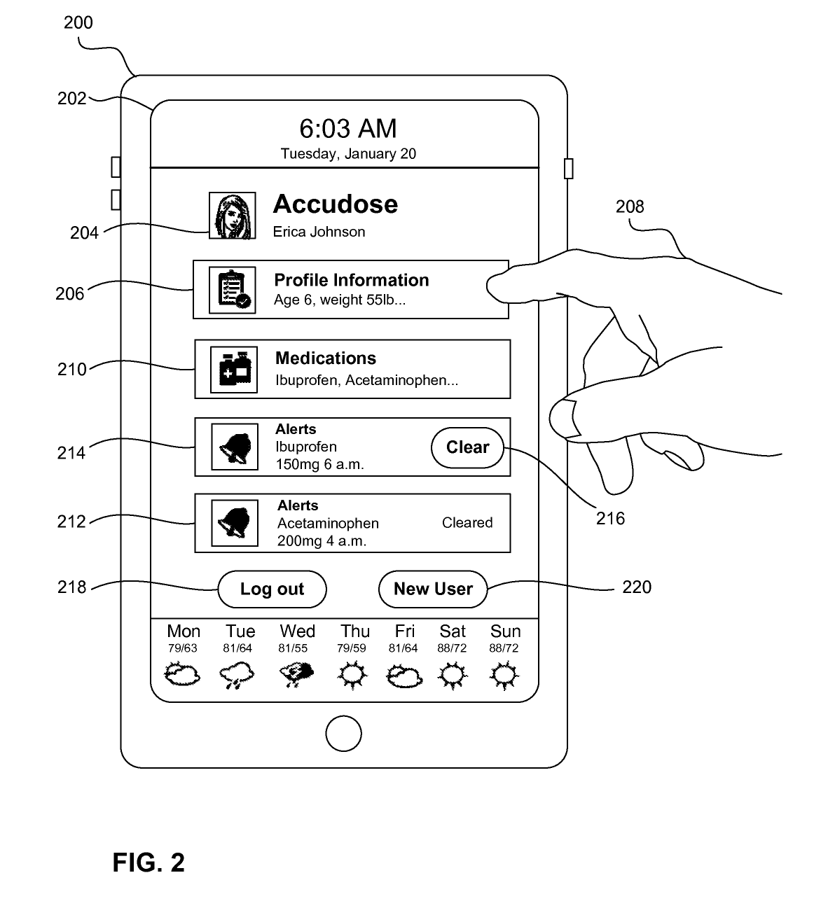

FIG. 2 shows a smartphone with a computerized dosing system app, consistent with an example embodiment of the invention. Here, a smartphone device 200 uses touchscreen display 202 to present information from an Accudose medication dosing app or application. The app shown includes dosing information for a logged in user named Erica Johnson, as shown at 204. In this example, a user can log in and log out, and can access multiple profiles, create profiles, and perform other such functions, but other embodiments will not have some or all of these features. User information for Erica Johnson's profile is input such as via profile information tab 206, which enables a user 208 to enter profile information for Erica Johnson. Here, age and weight are illustrated as information in the profile, but the profile in other examples includes information such as allergies, medications, chronic medical conditions, current illness, meal schedule, sleep schedule, school schedule, and other such information. The app also shows medications 210 that the profile subject is currently taking, which in this example include over-the-counter medications ibuprofen and acetaminophen. The user 208 can touch medications tab 210 to add additional medications, remove medications, change prescription information, or perform other such functions.

The app is operable to derive dosing information including a dose amount and a dosing schedule from the profile information and the medication information as shown here, which result in generation of alerts corresponding to the dosing schedule and amounts. Alerts generated from dosing derived from user profile information and medication information shown here are illustrated at 212 and 214. At 212, an acetaminophen alert is shown as having occurred at 4 a.m., and is indicated as cleared, meaning the dose has been administered. At 214, an alert that has not been cleared is shown, indicating that a 150 mg dose of ibuprofen was due at 6 a.m. and has not yet been administered. The user 208 in this example will administer the dose, then tap the “clear” button shown as part of the alert at 216 to clear the alert.

The computerized medication dosing app in the example of FIG. 2 further includes the ability to log in and log out, such as by using a password or pin number as shown at 218, to protect information stored by the app or accessible via the app. The user can also make profiles for multiple people and access them from within the app, such as by touching new user button 220 to create a new user or touching the active profile icon 204 to select another active profile.

The computerized medication dosing app shown in FIG. 2 in some examples is operable to function as a standalone application, storing medication, user profile, and other information on the smart phone device, but in other examples will store some or all of such information on a server or other system such as is illustrated in the example shown in FIG. 1.

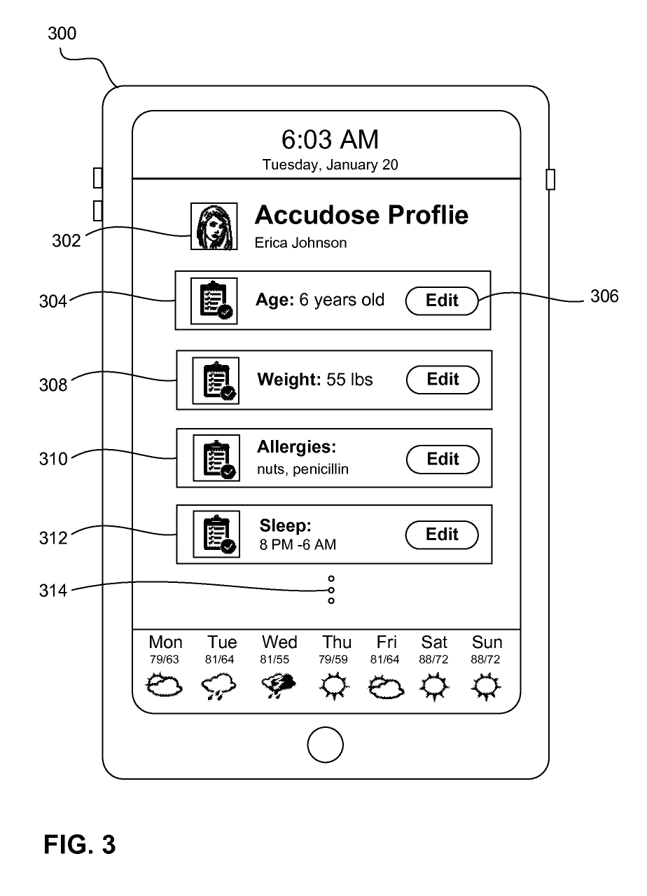

FIG. 3 shows a smartphone computerized dosing system app user profile information page, consistent with an example embodiment of the invention. Here, a user has elected to edit the profile of one or more people, such as by selecting a user by touching the user location shown at 204, or by touching the “new user” tab shown at 220 in FIG. 2. The user Erica Johnson's profile in this example includes a snapshot of the user as shown at 302, which may help some caregivers such as a daycare, physician, or babysitter ensure accurate identification of the child that is the subject of the profile.

Profile information shown here includes the person's age, as reflected at 304. The data can be edited, such as by hitting edit button 306, or can be specified in another way such as by inputting the person's birthdate or importing age information from another source. Similarly, the user's weight is shown at 308, and can be edited through similar means. Additional profile information in this example includes allergies as shown at 310 and sleep schedule as shown at 312, while dots 314 indicate that more user profile data can be found by scrolling down. Additional profile information includes in various examples medications, work schedule, meal schedule, dietary restrictions, chronic medical conditions, current medical conditions, and other such information as may be useful in determining medication dosing and scheduling.

Profile information is in some examples available to local users, such as where the profile information is stored local to smartphone 300. In other examples, such as that of FIG. 1, a user may grant other users access to profiles under their control, such as granting a grandparent, day care provider, babysitter, or other person access to a user's profile, optionally including some or all information associated with a person.

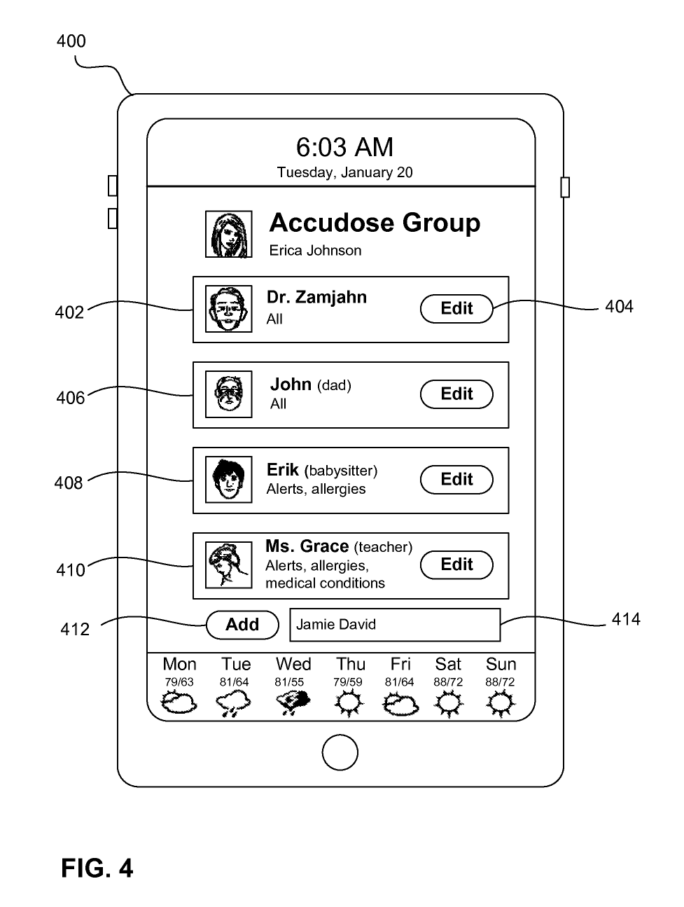

FIG. 4 shows a smartphone dosing system app group authorization page, consistent with an example embodiment of the invention. Here, a user is setting access for user Erica Johnson, and has granted access to Dr. Zamjahn, Erica's physician, as shown at 402. The access setting indicates that Dr. Zamjahn has access to all information for Erica, but access can be edited or restricted by using edit button 404. Similarly, parent John has been given access to all information for Erica's profile as shown at 406.

At 408, user Erik has been granted access to only medication alerts and allergies for user Erica, such that Erik will get alerts for Erica and can view information related to allergies such as nuts, but Erik cannot view information related to current or ongoing medical conditions or other profile information for Erica that he does not need.

Similarly, teacher Ms. Grace as shown at 410 has been given access to alerts and allergies, but is also given access to information regarding chronic medical conditions and current medical conditions so that she can aid in management of these conditions. If an owner of Erica's profile determines that more or less information should be shared with Ms. Grace, such as sharing additional information needed to help manage Erica's health care or removing access to Erica's information when Erica graduates from Ms. Grace's class, edits can be made by pressing the edit button.

Additional users are granted access in this example by tapping the add button 412, initiating a search for one or more users matching a name that a user enters at 414. Here, the user is searching for a user named Jamie David by name to add to Erica Johnson's profile access group, but in other examples the user can be identified by email, by cell phone number, or by other such means. Again, user thumbnail photos or other user information can help ensure that the correct Jamie David is found, ensuring that access to Erica's profile is granted to those who need it.

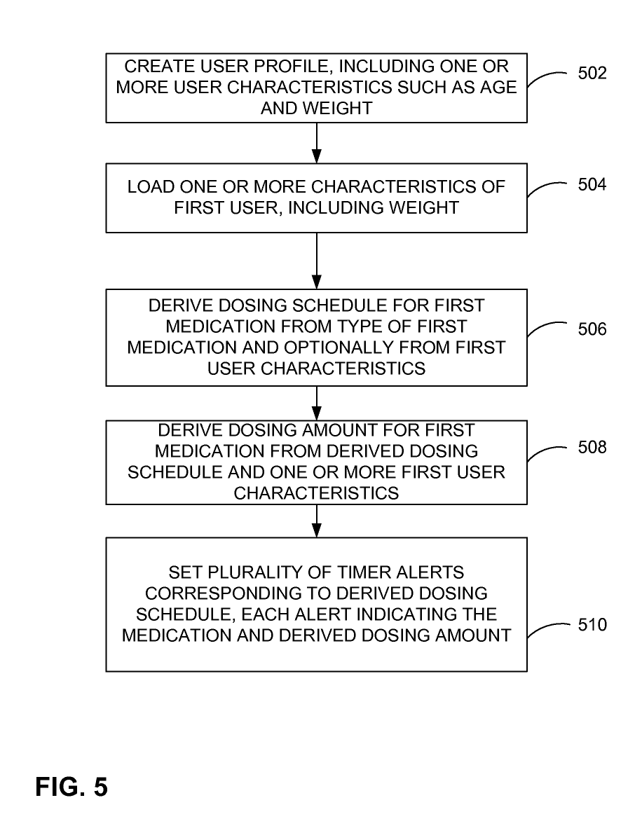

FIG. 5 is a flowchart of a method of providing computerized dosing, consistent with an example embodiment of the invention. At 502, a user creates a user profile for a person, including one or more user characteristics for the person such as weight or age. The computerized system loads user profile information at 504, such as weight, and derives a dosing schedule for a first medication based at least on the type of medication at 504. Deriving the dosing schedule in further examples includes using user characteristics, such as age, weight, sleeping schedule, or the like in determining the dosing schedule.

The computerized system determines a dosing amount at 508, based on the derived dosing schedule (which is based at least in part on the type of medication), and based on one or more user characteristics such as age or weight. The dosing schedule and dosing amount for the medication are used to set a plurality of timer alerts corresponding to the derived dosing schedule at 510, each alert indicating at least the medication and the derived dosing amount. In a further example, alerts can be set for multiple users, and the alert further indicates the person associated with the alert.

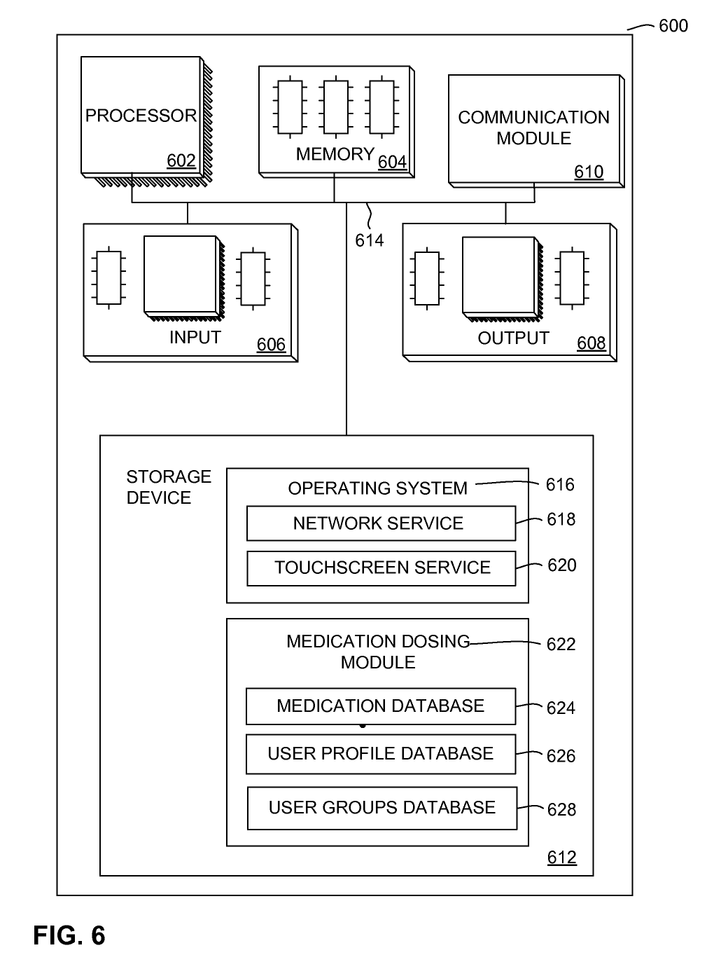

FIG. 6 is a computerized system comprising a computerized dosing module, consistent with an example embodiment of the invention. FIG. 6 illustrates only one particular example of computing device 600, and other computing devices 600 may be used in other embodiments. Although computing device 600 is shown as a standalone computing device, computing device 600 may be any component or system that includes one or more processors or another suitable computing environment for executing software instructions in other examples, and need not include all of the elements shown here. For example, computing device 600 includes in various embodiments a server, a smartphone, a tablet, a persona computer, or a combination thereof.

As shown in the specific example of FIG. 6, computing device 600 includes one or more processors 602, memory 604, one or more input devices 606, one or more output devices 608, one or more communication modules 610, and one or more storage devices 612. Computing device 600, in one example, further includes an operating system 616 executable by computing device 600. The operating system includes in various examples services such as a network service 618 and a touchscreen interface service 620. One or more applications, such as medication dosing module 622 are also stored on storage device 612, and are executable by computing device 600.

Each of components 602, 604, 606, 608, 610, and 612 may be interconnected (physically, communicatively, and/or operatively) for inter-component communications, such as via one or more communications channels 614. In some examples, communication channels 614 include a system bus, network connection, inter-processor communication network, or any other channel for communicating data. Applications such as medication dosing module 622 and operating system 616 may also communicate information with one another as well as with other components in computing device 600.

Processors 602, in one example, are configured to implement functionality and/or process instructions for execution within computing device 600. For example, processors 602 may be capable of processing instructions stored in storage device 612 or memory 604. Examples of processors 602 include any one or more of a microprocessor, a controller, a digital signal processor (DSP), an application specific integrated circuit (ASIC), a field-programmable gate array (FPGA), or similar discrete or integrated logic circuitry.

One or more storage devices 612 may be configured to store information within computing device 600 during operation. Storage device 612, in some examples, is known as a computer-readable storage medium. In some examples, storage device 612 comprises temporary memory, meaning that a primary purpose of storage device 612 is not long-term storage. Storage device 612 in some examples is a volatile memory, meaning that storage device 612 does not maintain stored contents when computing device 600 is turned off. In other examples, data is loaded from storage device 612 into memory 604 during operation. Examples of volatile memories include random access memories (RAM), dynamic random access memories (DRAM), static random access memories (SRAM), and other forms of volatile memories known in the art. In some examples, storage device 612 is used to store program instructions for execution by processors 602. Storage device 612 and memory 604, in various examples, are used by software or applications running on computing device 600 such as recommendation module 622 to temporarily store information during program execution.

Storage device 612, in some examples, includes one or more computer-readable storage media that may be configured to store larger amounts of information than volatile memory. Storage device 612 may further be configured for long-term storage of information. In some examples, storage devices 612 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 600, in some examples, also includes one or more communication modules 610. Computing device 600 in one example uses communication module 610 to communicate with external devices via one or more networks, such as one or more wireless networks. Communication module 610 may be a network interface card, such as an Ethernet card, an optical transceiver, a radio frequency transceiver, or any other type of device that can send and/or receive information. Other examples of such network interfaces include Bluetooth, 3G or 4G, WiFi radios, and Near-Field Communication s (NFC), and Universal Serial Bus (USB). In some examples, computing device 600 uses communication module 610 to wirelessly communicate with an external device such as via public network 122 of FIG. 1.

Computing device 600 also includes in one example one or more input devices 606. Input device 606, in some examples, is configured to receive input from a user through tactile, audio, or video input. Examples of input device 606 include a touchscreen display, a mouse, a keyboard, a voice responsive system, video camera, microphone or any other type of device for detecting input from a user.

One or more output devices 608 may also be included in computing device 600. Output device 608, in some examples, is configured to provide output to a user using tactile, audio, or video stimuli. Output device 608, in one example, includes a display, a sound card, a video graphics adapter card, or any other type of device for converting a signal into an appropriate form understandable to humans or machines. Additional examples of output device 608 include a speaker, a light-emitting diode (LED) display, a liquid crystal display (LCD), or any other type of device that can generate output to a user.

Computing device 600 may include operating system 616. Operating system 616, in some examples, controls the operation of components of computing device 600, and provides an interface from various applications such as recommendation module 622 to components of computing device 600. For example, operating system 616, in one example, facilitates the communication of various applications such as medication dosing module 622 with processors 602, communication unit 610, storage device 612, input device 606, and output device 608. Applications such as medication dosing module 622 may include program instructions and/or data that are executable by computing device 600. As one example, medication dosing module 622 and its medication database 624, user profile database 626, and user groups database 628 may include instructions that cause computing device 600 to perform one or more of the operations and actions described in the examples presented herein.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

1. A computerized method of dosing medication, comprising:
loading via a computerized system one or more user characteristics for a first user from a user profile for the first user, the user characteristics including a weight of the first user;
deriving via the computerized system a dosing schedule for a first medication from at least one of a type of the first medication and the one or more user characteristics for the first user;
deriving via the computerized system a dosing amount for the first medication from the one or more characteristics for the first user and the derived dosing schedule for the first user; and
setting in the computerized system a plurality of timer alerts corresponding to the derived dosing schedule, each of the timer alerts indicating the medication and derived dosing amount.

2. The method of claim 1, wherein one or more of the loading one or more user characteristics, deriving a dosing amount, deriving a dosing schedule, and setting a plurality of timer alerts are performed by executing program instructions in a computerized system.

3. The method of claim 2, wherein the computerized system comprises at least one of a smart phone and a tablet computer.

4. The method of claim 1, wherein user characteristics further comprise one or more of age, allergies, sensitivities, meal schedule, sleeping hours, school hours, and other medications taken.

5. The method of claim 4, wherein the dosing schedule is derived from the first medication and at least one of meal schedule, sleeping hours, school hours, and other medications taken.

6. The method of claim 1, wherein the dosing amount is derived from at least the weight of the first user.

7. The method of claim 1, wherein the first medication is derived from at least the age of the first user.

8. The method of claim 1, wherein deriving a dosing schedule further comprises setting a schedule for alternating medications.

9. The method of claim 1, wherein deriving a dosing schedule further comprises determining whether two or more medications contain ingredients that are the same or that interact, and adjusting the dosing schedule based on the cumulative dose or interaction.

10. The method of claim 1, wherein the first medication comprises at least one of over-the-counter medication and prescription medication.

11. The method of claim 1, wherein setting a plurality of timer alerts further comprises setting alerts for a specified number of days based on at least one of the medication, a prescription, and a condition being treated.

12. The method of claim 1, further comprising providing access to at least one of the first user's user profile, user characteristics, dosing amount, dosing schedule, and timer alerts to another user.

13. The method of claim 12, wherein the first user's profile comprises at least one of other medications taken, chronic medical conditions, immunizations, allergies, sensitivities, and other medical history.

14. The method of claim 12, wherein access to the first user's profile is provided by the first user or a guardian of the first user.

15. The method of claim 12, wherein access to the first user's profile is provided via membership in a group or circle.

16. The method of claim 1, further comprising storing a dosing history for the first user.

17. The method of claim 1, wherein the computerized method is further operable to dose medication for two or more users.

18. The method of claim 17, wherein each of the loading one or more user characteristics, deriving a dosing amount, deriving a dosing schedule, and setting a plurality of timer alerts are performed separately for each of the two or more users.

19. A computerized device, comprising:
a processor; and
a medication dosing module comprising instructions executable on the processor that when executed are operable to:
load one or more user characteristics for a first user from a user profile for the first user, the user characteristics including a weight of the first user;
derive a dosing schedule for a first medication from at least one of a type of the first medication and the one or more user characteristics for the first user;
derive a dosing amount for the first medication from the one or more characteristics for the first user and the derived dosing schedule for the first user; and
set a plurality of timer alerts corresponding to the derived dosing schedule, each of the timer alerts indicating the medication, dose, and user.

20. A machine-readable medium with instructions stored thereon, the instructions when executed operable to cause a computerized system to:
load one or more user characteristics for a first user from a user profile for the first user, the user characteristics including a weight of the first user;
derive a dosing schedule for a first medication from at least one of a type of the first medication and the one or more user characteristics for the first user;
derive a dosing amount for the first medication from the one or more characteristics for the first user and the derived dosing schedule for the first user; and
set a plurality of timer alerts corresponding to the derived dosing schedule, each of the timer alerts indicating the medication, dose, and user.
